(19) United States
(12) Patent Application Publication
(10) Pub. No.: US 2004/0088294 A1
(43) Pub. Date: May 6, 2004

(54) Method and system for deploying networked storage devices

(76) Inventor: Gary S. Lerhaupt, Austin, TX (US)

Correspondence Address: HAMILTON & TERRILE, LLP, P.O. BOX 203518, AUSTIN, TX, 78720, US

(21) Appl. No.: 10/286,245

(22) Filed: Nov. 1, 2002

(51) Int. Cl. G06F 17/30

(52) U.S. Cl. 707/8

(57) ABSTRACT

Networked storage devices are accessed by user nodes through a consistent symbolic link naming convention that associates a symbolic link to a storage device unique identifier. User node operating system storage device directory naming conventions are mapped to the symbolic links by selecting a user node as a master and mapping symbolic links to directory names and unique identifiers for the networked storage devices with a master configuration engine. A configuration file with the symbolic link mapping generated by the master configuration engine is provided to configuration engines associated with other user nodes so that the other user nodes are configured to have the symbolic links point to consistent storage devices by reference to the unique identifiers. In the event of differences in user node directory names and subsequent changes to directory names for one or more user nodes, symbolic links remain associated with predetermined storage devices by reference to the unique identifiers.

### BACKGROUND OF THE INVENTION

1. Field of the Invention

The present invention relates in general to the field of information handling system storage networks, and more particularly to a method and system for deploying networked storage devices.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Increased use of information handling systems has resulted in increased storage of information. In order to store information in a more efficient and cost effective manner, storage devices are often interfaced with a network and organized as a storage area network (“SAN”) or other database system, such as an Oracle Real Application Cluster (“RAC”) for access by a number of user nodes. Networked storage devices are a flexible, robust and scalable solution since additional storage devices are added or removed to meet changing storage needs and to replace failed storage devices. In order to track storage devices added or removed from a network, some operating systems, such as Microsoft Windows, automatically write signatures on disks. Other operating systems, such as Unix-based operating systems like Linux, use a directory naming convention that presents storage devices to a user in the order in which the operating system discovers them during boot. For instance, Linux handles SCSI storage devices by listing them in the/dev directory with the prefix “sd” followed by an alphanumeric handle assigned as the storage devices are discovered. As an example, the first SCSI storage device is designated in the /dev directory as “sda,” the second is designated “sdb,” and so forth. Subsequent numbering, such as “sdb1”, designates partitions within the storage device.

One difficulty with the alphanumeric directory naming convention used by Linux is that adding or removing storage devices often results in changes to the directory names associated with the storage devices. For instance, if a storage device fails that is normally discovered second during boot, its directory name of “sdb” will generally be assigned to the storage device normally discovered third and designated “sdc.” This re-ordering of storage device names complicates a user node's ability to access data. Further, in a multi-user node storage area network, different user nodes may have different directory naming conventions based on the order of discovery of storage devices resulting in additional complication in accessing stored data. Each user node generally tracks storage devices independently without consistent naming across storage devices.

One solution to this difficulty is to write labels to storage devices, such as with the e21label program. The e21label program is typically used in conjunction with ext2 or ext3 file systems to write unique labels in the file system of the storage devices. However, disparate file systems each maintain their own implementation for handling the labeling process resulting in certain partitions, such as swap partitions, sometimes having no file system at all. Further, some storage networks do not use file systems written on the partitions of storage devices, and without file systems present, it is not possible to use labels to confirm storage devices. For instance, storage devices that use raw device mapping, such as Oracle RAC configured storage devices, write directly to raw devices without verifying the correctness of disk mappings so that changes to the storage devices that result in re-naming may lead to incorrect mapping for raw device accesses.

### SUMMARY OF THE INVENTION

Therefore a need has arisen for a method and system which deploys networked storage devices with a consistent naming convention for access by plural user nodes having operating systems that use directory naming conventions for storage devices.

A further need exists for a method and system which maintains a consistent naming convention as networked storage devices are added or removed from a network having user nodes with operating systems that use directory naming conventions for storage devices.

In accordance with the present invention, a method and system are provided which substantially reduce the disadvantages and problems associated with previous methods and systems for deploying networked storage devices for access by user nodes having operating systems that use directory naming conventions for storage devices. Symbolic links map to a selected user node's networked storage device directory using the storage device's inherent unique identifiers. A master configuration file is utilized to store symbolic link to storage device directory mappings, which can be used to configure other user nodes that interface with the networked storage devices. Thus, a consistent set of symbolic links are used to access storage devices by each user node with the consistency maintained by reference to storage device unique identifiers.

More specifically, networked storage devices are deployed so that each user node that accesses networked storage devices performs accesses with a consistent set of symbolic links. A master configuration engine associated with a master user node generates a master configuration file that maps a symbolic link for each storage device with an operating system directory name for the storage device and a unique identifier queried from the storage device. The master configuration file is then transferred to other user nodes that access the networked storage devices. A configuration engine associated with each additional user node maps symbolic links of the master configuration file to each user node's directory names. The unique identifiers are referenced by the configuration engine to ensure that the same storage device is accessed by the same symbolic link on each deployed user node, even if the user nodes have different directory names. As directory names change due to the addition or removal of storage devices, the configuration engines map symbolic links to directory names by reference to the unique identifiers so that the symbolic links consistently point to the same storage devices.

The present invention provides a number of important technical advantages. One example of an important technical advantage is that networked storage devices are deployed for access by plural user nodes with a consistent naming convention. For instance, user nodes with the Linux operating system access data from a storage area network through symbolic links mapped to directory names. A configuration engine, maps symbolic links to the directory names of a selected user node via the storage device's unique identifier. The map of symbolic links and unique identifiers for the selected user node is then used to deploy other user nodes that access the storage area network to consistently map each user node's directory names to the same symbolic links. Thus, the symbolic links deploy networked storage devices across a storage area network with a consistent naming convention.

Another example of an important technical advantage of the present invention is that user nodes that access data from a storage area network maintain a consistent naming convention as networked storage devices are added or removed from the network. User nodes with operating systems that use directory naming conventions for storage devices map the naming conventions to symbolic links via the unique identifiers. As storage devices are added or removed from the network resulting in changes to the directory naming convention, the changed directory names are mapped to symbolic links by reference to storage device unique identifiers so that user nodes may continue to access data from storage devices with the consistent use of symbolic links with each symbolic link continuing to access the same networked storage device.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a storage area network having storage deployed with symbolic links; and

FIG. 2 depicts a flow diagram of the process for deploying storage devices with symbolic links.

### DETAILED DESCRIPTION

User node information handling systems that access networked storage information handling systems through a directory naming convention, such as that of the Linux operating system, present a complex access configuration that is difficult to track as the accessed storage information handling systems change. The present invention automatically deploys storage information handling systems with a consistent naming convention by coupling operating system directory names with unique identifiers of the networked storage information handling systems through a consistent set of symbolic links. For purposes of this application, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

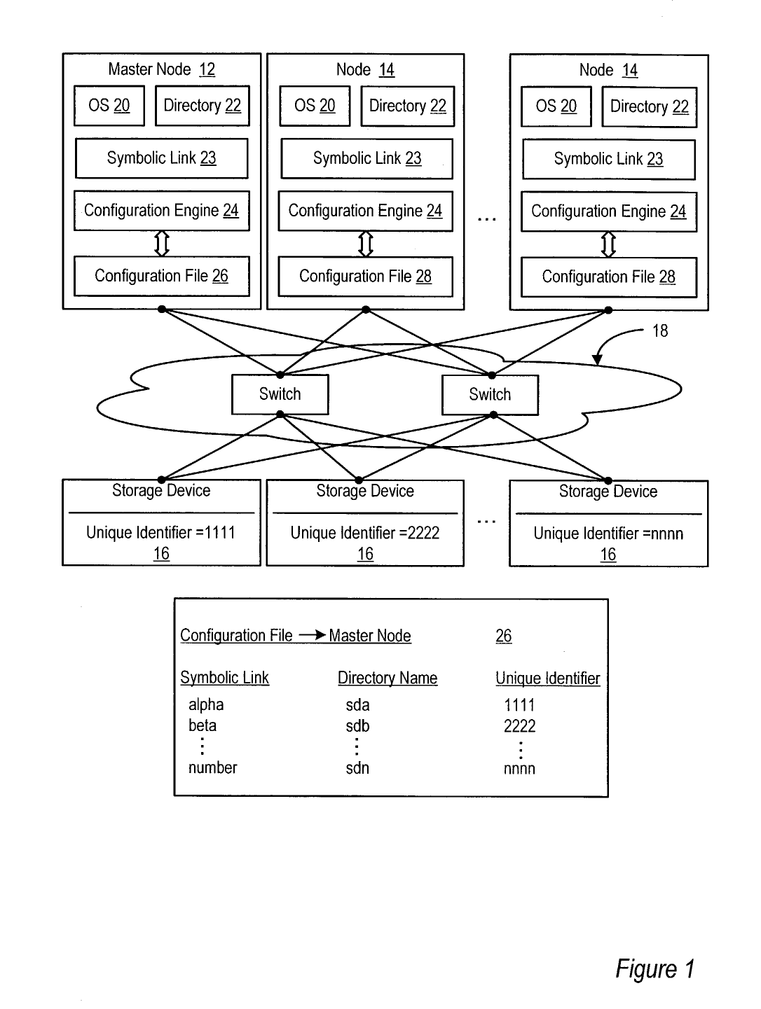

Referring now to FIG. 1, a block diagram depicts a storage area network that accesses information with a consistent set of symbolic links. A master user information handling system node 12 and plural other user information handling system nodes 14 access plural storage information handling systems 16 through a network 18. Storage information handling systems 16 are, for instance, SCSI disk drives configured as a storage area network or, alternatively, other database system, such as networked IDE devices or an Oracle RAC that accesses information from raw devices. Master user node 12 and the plural other user nodes 14 each have an operating system 20 that names storage information handling systems 16 with a directory 22 naming convention. For instance, the Linux operating system names storage information handling systems 16 alphanumerically as the storage information handling systems are discovered during boot. Each user node then accesses information from storage information handling systems through symbolic links 23 created by a configuration engine 24 with the symbolic links 23 pointing to the directory naming convention stored in directory 22.

In order to deploy a storage area network with a consistent naming convention for storage information handling systems, each user node that accesses information is provided with a configuration engine 24. Configuration engine 24 of master user node 12 creates a symbolic link for each detected storage information handling system 16 and queries each storage information handling system 16 for a unique identifier, such as a device serial number. Configuration engine 24 uses the directory names generated by operating system 20, the unique identifiers associated with each directory name and the symbolic links to generate a master configuration file 26. For instance, configuration engine 24 queries the storage information handling system 16 with the directory name of “sda” to obtain its unique identifier of “1111”.

Once all of the directory names of master node 12 are associated with a symbolic link via the unique identifier, applications running on master node 12 use the symbolic links to access information from networked information handling systems 16. For instance, the symbolic link “alpha” is used to access information through the master node 12 operating system 20 directory name “sda”. At each boot of master node 12 or upon the manual restart of configuration engine 24, configuration engine 24 verifies the consistency of configuration file 26 by querying unique identifiers from storage information handling systems 16 to confirm that each directory name and symbolic link are associated with the same storage device. If a directory name for a queried unique identifier changes, such as may occur if a storage information handling system fails or is removed from the network, then configuration engine 24 updates configuration file 26 to ensure that each symbolic link continues to point to the same information handling system even though its directory name changes by referencing the unique identifier.

Symbolic links are deployed in a consistent manner across other user nodes 14 by transferring the master configuration file 26 to each additional user node 14 and configuring the additional user nodes to access information through the symbolic links. For instance, master configuration file 26 is copied across network 18 to each additional user node 14, or otherwise transferred, such as with floppy disk, serial or Ethernet interface. A configuration engine 24 associated with each user node 14 detects the master configuration file 26 and applies it to generate a configuration file 28 that is specific to each user node 14. For each user node 14, a configuration engine 24 queries each storage information handling system name of directory 22 to obtain each name's unique identifier. Configuration engine 24 then maps the symbolic links from master configuration file 26 to the directory names of user node 14 by reference to the unique identifiers. As an example, if a user node 14 has a directory name of “sda” for a storage information handling system 16 with a unique identifier of “2222”, then configuration engine 24 maps the symbolic link “beta” to directory name “sda” for that user node 14. In this manner each user node 12 or 14 that access information by reference to the “beta” symbolic link will obtain information from the same storage information handling system.

Automatic deployment of storage devices through the symbolic link naming convention uses a master configuration file 26 to set up each user node to access information by referencing a consistent symbolic link name for each storage device that, in turn, points to an independent internal storage device name of the operating system 20 directory 22. Symbolic links are maintained to point to consistent storage information handling systems 16 as directory names of directory 22 change by reference to unique identifiers. For instance, if storage information handling system “beta” is removed from network 18, then directory name “sdb” will be assigned to the next discovered device, in this example the device “number”. Each user node 14 will ensure consistency in the symbolic link naming convention by ensuring that the storage information handling system directory name that is associated with the unique identifier “nnnn” points to the symbolic link “number”. As additional storage information handling systems are deployed, the configuration engine 24 of master user node 12 assigns a symbolic link to the added storage devices and provides the symbolic link and associated unique identifier to the other user nodes 14.

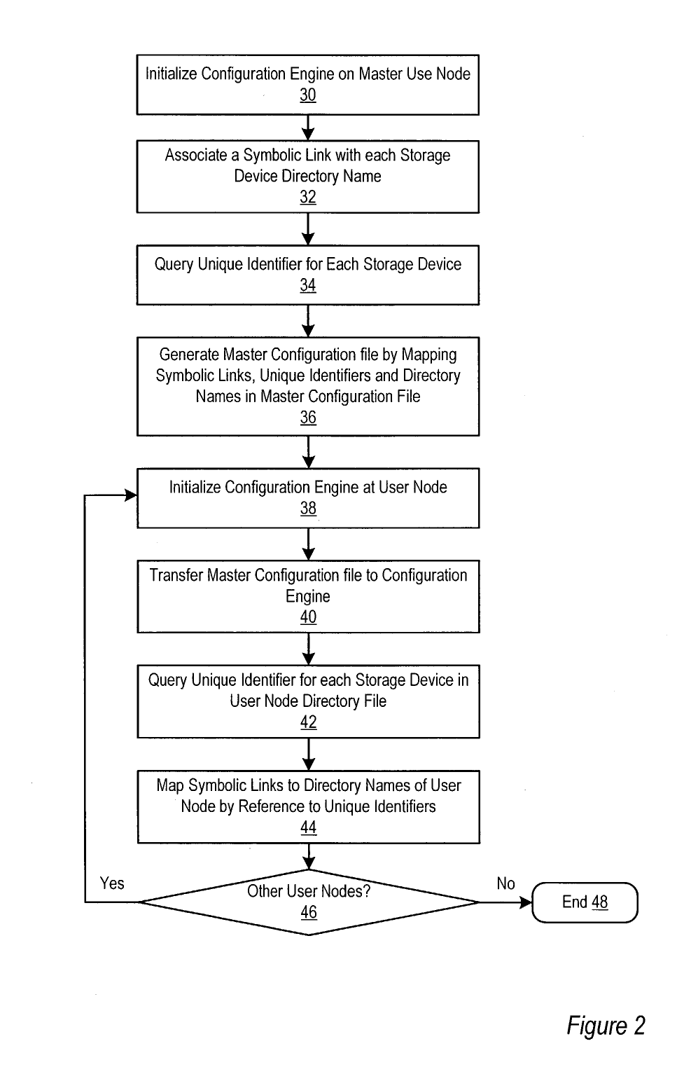

Referring now to FIG. 2, a flow diagram depicts the process for deploying storage information handling systems to a storage network for access by plural user nodes, such as in a storage area network or RAC cluster, that use a directory naming convention, such as Linux-based user nodes. The process begins at step 30 with initialization of the configuration engine on a user node selected as the master user node. At step 32, the configuration engine associates a symbolic link with each storage device directory name from the Linux directory of discovered storage devices. At step 34, the configuration engine queries networked storage devices to obtain a unique identifier for each. If a storage device lacks a unique identifier, the configuration engine will not allow assignment of a symbolic link name to the storage device. Then, at step 36 the configuration engine generates a master configuration file by mapping symbolic links, unique identifiers and directory names. The master configuration file is used to allow applications running on the master node to access storage devices by reference to the symbolic links.

At step 38, the configuration engine associated with an additional user node is initialized. At step 40, the master configuration file is transferred to the configuration engine and at step 42 the configuration engine queries storage device names in the user node directory for unique identifiers. At step 44, the configuration engine maps symbolic links provided by the master configuration file to directory names of the user node by reference to the unique identifiers so that the user node accesses information from storage devices with the same symbolic links pointing to the same storage devices as the master user node. For instance, with a Linux-based storage area network the deployment for the user node is then completed by creating mount points and mounting partitions to their mount points as with the master user node. The process then proceeds to step 46 for the master configuration engine to determine if additional user nodes are interfaced with the network. If not, the process ends at step 48. If an additional user nodes interfaces with the network, the process returns to step 38 and repeats until deployment is complete with each user node configured to access networked storage devices with a consistent set of symbolic links.

The use symbolic links improves scalability and flexibility for Linux-based storage networks by overcoming the tendency of Linux to re-name storage devices at each boot. The configuration file allows the addition or removal of devices with symbolic links adjusting to point to internal directory names so that consistent access is maintained. For instance, shared raw device access in a clustered shared storage environment is supported with the configuration engine treating raw devices as a special type of symbolic link within its scripts. The master node configuration file includes raw device to storage device mappings and is transferred to other nodes in the cluster so that each node creates raw mappings by reference to unique identifiers.

Although the present invention has been described in detail, it should be understood that various changes, substitutions and alterations can be made hereto without departing from the spirit and scope of the invention as defined by the appended claims.

What is claimed is:

1. A system for deploying networked storage devices, the system comprising:
plural storage devices, each storage device having a unique identifier;
plural user nodes operable to retrieve information from the storage devices, each user node having an operating system, each operating system having a naming convention for the storage devices;
a network interfacing the storage devices and the user nodes; and
a configuration engine associated with each user node, a selected user node configuration engine operable to generate a configuration file that maps the selected user node naming convention for the storage devices with the storage device unique identifiers by associating a symbolic link with each storage device, the selected user node configuration engine further operable to deploy the configuration file to the remaining user nodes for mapping the storage devices to each user node's naming convention with the symbolic links by reference to the unique identifiers.

2. The system of claim 1 wherein the configuration engine is further operable to manage changes to a user node naming convention by re-mapping the naming convention and symbolic links by reference to the unique identifiers, the re-mapping maintaining the symbolic links associations with the storage devices.

3. The system of claim 1 wherein the user nodes are operable to retrieve data from a selected storage device by reference to a symbolic link associated with the storage device.

4. The system of claim 1 wherein the operating system naming convention presents storage devices as directories labeled in order of discovery of the storage devices at boot.

5. The system of claim 1 wherein the operating system comprises Linux.

6. The system of claim 5 wherein the storage devices comprise SCSI disk drives.

7. The system of claim 5 wherein the storage devices comprise raw devices operable to store information as an Oracle database.

8. A method for deploying storage devices to a network for access of stored information by plural information handling system nodes, the method comprising:
interfacing plural storage devices and plural user nodes through a network;
naming each storage device at each user node with a directory name;
selecting one of the user nodes for configuration;
mapping symbolic links for the selected user node, each symbolic link associating a storage device directory name and unique identifier;
providing the mapping of the selected user node to a second of the user nodes; and
referencing the storage device unique identifiers to map the symbolic links to the storage device directory names of second user node.

9. The method of claim 8 further comprising mapping the symbolic links to the storage device directory names for each user node interfaced with the network.

10. The method of claim 8 wherein naming each storage device further comprises:
labeling the storage devices alphanumerically in the order in which the user node discovers the storage devices during boot.

11. The method of claim 10 wherein the storage devices are labeled by a Unix operating system.

12. The method of claim 8 wherein the storage devices comprise raw devices.

13. The method of claim 8 wherein the storage devices comprise SCSI devices.

14. The method of claim 8 wherein the devices comprise IDE devices.

15. The method of claim 8 wherein the plural nodes and-plural storage devices are configured as a storage area network.

16. The method of claim 8 further comprising retrieving information from a storage device with the user node by identifying the storage device with its associated symbolic link.

17. The method of claim 8 further comprising:
altering the storage devices associated with the network to alter the user node directory names; and
maintaining the association of symbolic links with storage devices by reference to the unique identifiers.

18. A storage area network comprising:
plural storage information handling systems, each storage information handling system having a unique identifier;
plural user information handling systems for accessing data stored on the storage information handling systems, each user information handling system having a directory of names for discovered storage information handling systems;
a network interfacing the storage and user information handling systems;
a master configuration engine associated with a predetermined user information handling system and operable to configure symbolic links for the selected user information handling system, the symbolic links associating unique identifiers with the directory of names of the storage information handling systems; and
a slave configuration engine associated with each of one or more predetermined storage information handling systems, each slave configuration engine operable to receive the symbolic links from the master configuration engine and to configure an associated user information handling system with the symbolic links so that each symbolic link points to a consistent storage information handling system based on the unique identifiers.

19. The storage area network of claim 18 wherein the user information handling systems are further operable to communicate with storage information handling systems through the symbolic links.

20. The storage area network of claim 19 wherein each configuration engine is further operable to re-configure symbolic links in the event of changes to user information handling system directory names so that each symbolic link remains associated with the same storage information handling system.
